(19) United States
(12) Patent Application Publication
(10) Pub. No.: US 2026/0296548 A1
(43) Pub. Date: Oct. 1, 2026

(54) TRAILER

(71) Applicant: HONDA MOTOR CO., LTD., Tokyo (JP)

(72) Inventors: Fumio Minami, Wako-shi (JP); Taichi Kubota, Wako-shi (JP); Fumika Mizuno, Wako-shi (JP); Tatsuya Yamazaki, Wako-shi (JP); Satoshi Nakamura, Wako-shi (JP); Shin Murakami, Wako-shi (JP); Kota Ueda, Wako-shi (JP)

(21) Appl. No.: 19/552,172

(22) Filed: Feb. 27, 2026

(30) Foreign Application Priority Data
Mar. 31, 2025 (JP) 2025-060120

(51) Int. Cl. B62D 21/14

(52) U.S. Cl. CPC B62D 21/14

(57) ABSTRACT

A trailer, which includes a main body portion constituting the trailer, at least two left and right wheels supported by the main body portion, and a connection portion connecting the main body portion to a vehicle, and is towed by the vehicle, includes: an attachment connection portion to which various attachments are detachably connected; and an auxiliary wheel that is supported so as to be changeable in position with respect to the main body portion.

### INCORPORATION BY REFERENCE

The present application claims priority under 35 U.S.C.§119 to Japanese Patent Application No. 2025-060120 filed on Mar. 31, 2025. The content of the application is incorporated herein by reference in its entirety.

### BACKGROUND

### Technical Field

The present invention relates to a trailer.

### Related Art

Conventionally, there is known a technique related to a tractor having an attachment connection portion for detachably connecting an attachment and capable of driving the attachment by utilizing tractor power (see, for example, JP S58-024108 U).

### SUMMARY

However, in the technique described in JP S58-024108 U, the attachment is detachably connected to the tractor, but the tractor is required to have a configuration corresponding to the attachment.

The present invention has been made in view of the above-described circumstance, and an object of the present invention is to provide a trailer that is capable of use without being limited to a vehicle and flexible use with attachments.

A trailer, which includes a main body portion constituting the trailer, at least two left and right wheels supported by the main body portion, and a connection portion connecting the main body portion to a vehicle, and is towed by the vehicle, includes: an attachment connection portion to which various attachments are detachably connected; and an auxiliary wheel that is supported so as to be changeable in position with respect to the main body portion.

It is possible to provide the trailer that is capable of use without being limited to the vehicle and flexible use with attachments.

### BRIEF DESCRIPTION OF DRAWINGS

FIG. 1 is a view illustrating a state where a trailer according to an embodiment is connected to a vehicle;

FIG. 2 is a right side view of the trailer according to the embodiment;

FIG. 3 is a perspective view of the trailer according to the embodiment as viewed from the right front;

FIG. 4 is a perspective view of the trailer according to the embodiment as viewed from the right rear;

FIG. 5 is a plan view of the trailer according to the embodiment;

FIG. 6 is a perspective view of a base frame of the trailer;

FIG. 7 is a cross-sectional view of a main part of the trailer corresponding to a cross section taken along line VII-VII of FIG. 5;

FIG. 8 is a perspective view illustrating a peripheral part of a PTO output shaft;

FIG. 9 is a rear view of the main part of the trailer;

FIG. 10 is an exploded perspective view of a first auxiliary wheel support member;

FIG. 11 is a cross-sectional view taken along line XI-XI of FIG. 5;

FIG. 12 is a cross-sectional view taken along line XII-XII of FIG. 5;

FIG. 13 is a view illustrating a variation of an auxiliary wheel support member of the trailer according to the embodiment;

FIG. 14 is a view illustrating a state of the trailer when the auxiliary wheel support member is attached; and

FIG. 15 is a functional explanatory diagram of the embodiment.

### DETAILED DESCRIPTION

Embodiments of the present invention will be described below with reference to the drawings. Note that, in the description, directions such as front, rear, left, right, up, and down are the same as the directions with respect to a vehicle body unless otherwise specified. In each of the drawings, a reference sign FR denotes a front side of the vehicle body, a reference sign UP denotes an upper side of the vehicle body, and a reference sign LH denotes a left side of the vehicle body.

### Embodiment

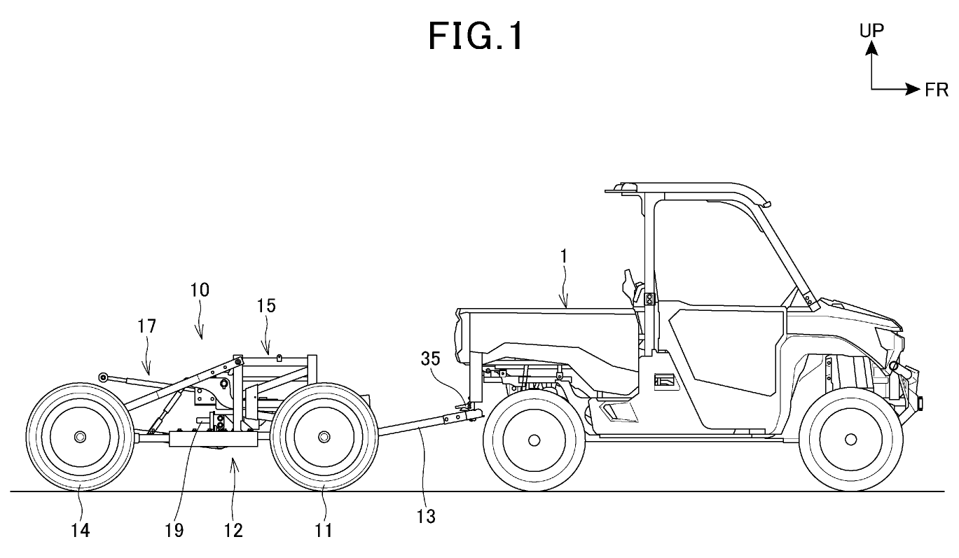

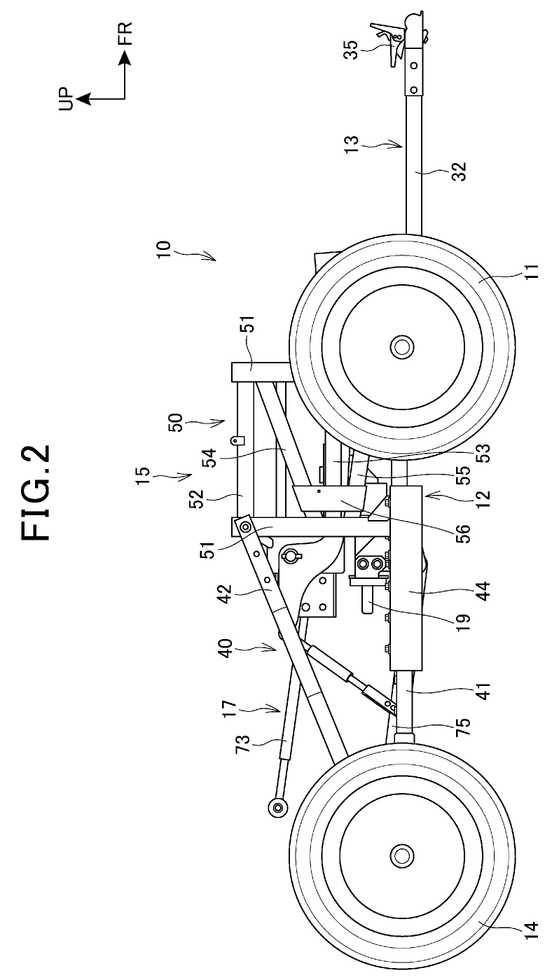

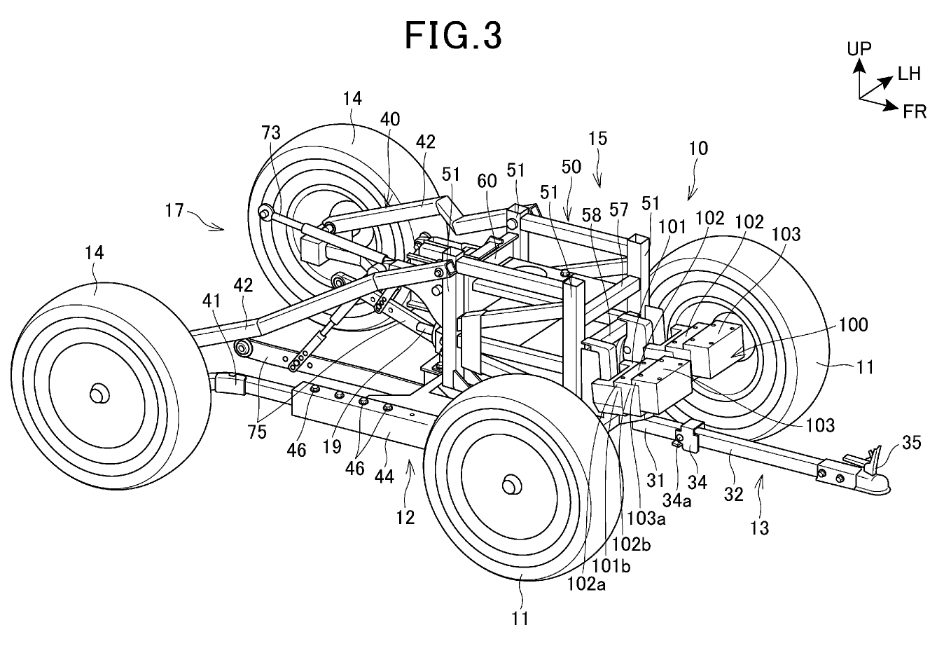

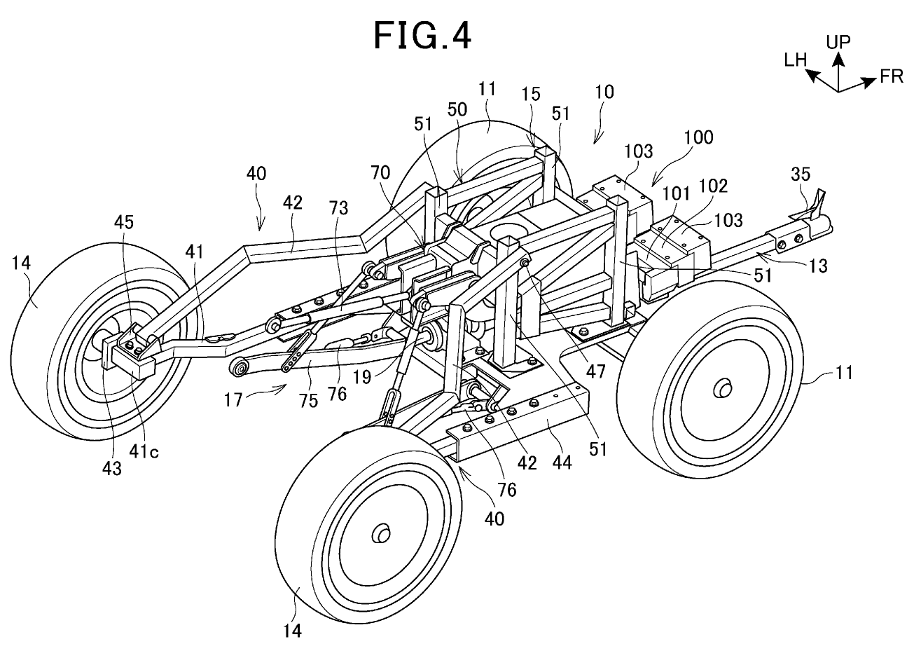

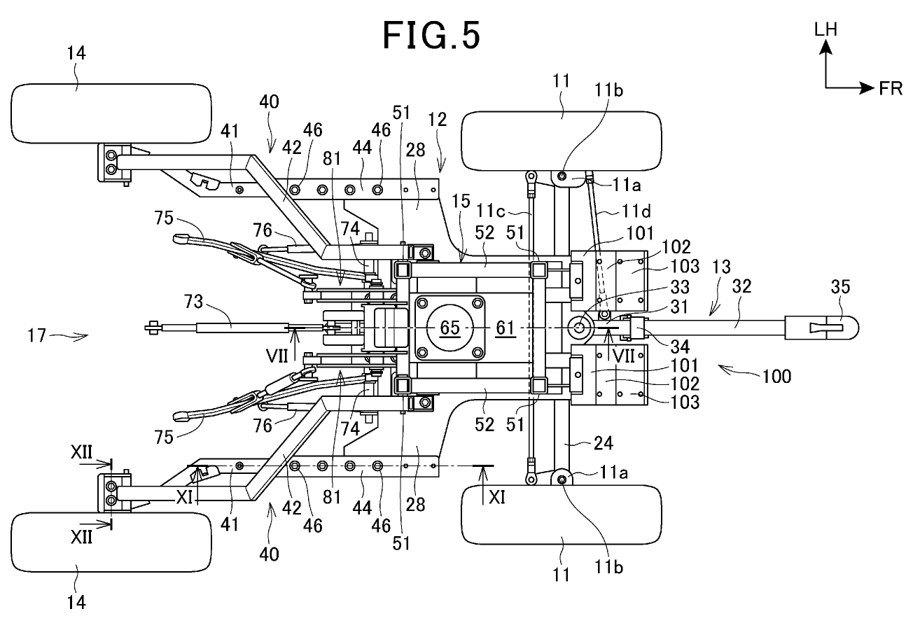

FIG. 1 is a view illustrating a state where a trailer 10 according to an embodiment is connected to a vehicle 1. FIG. 2 is a right side view of the trailer 10 according to the embodiment. FIG. 3 is a perspective view of the trailer 10 according to the embodiment as viewed from the right front. FIG. 4 is a perspective view of the trailer 10 according to the embodiment as viewed from the right rear. FIG. 5 is a plan view of the trailer 10 according to the embodiment.

The trailer 10 according to the embodiment includes a main body portion 12 including wheels 11 on the left and right, a towing rod (connection portion) 13 extending forward from the main body portion 12, a power unit portion (drive source) 15 provided in the main body portion 12, a three-point link mechanism (attachment connection portion) 17 extending rearward from the main body portion 12, and a PTO output shaft (output shaft) 19 that outputs a driving force of the power unit portion 15.

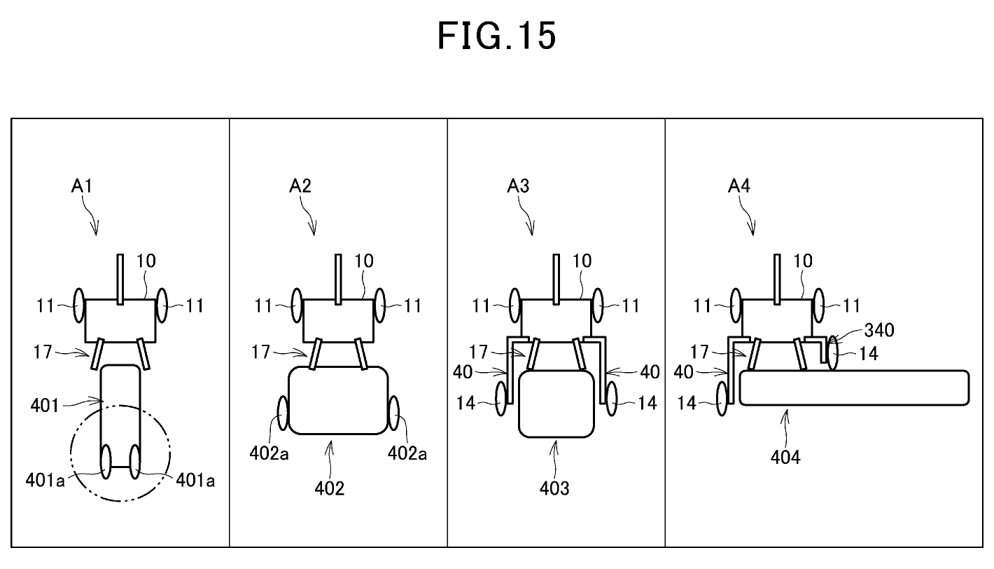

The trailer 10 is connected to the vehicle 1 having no PTO output shaft, for example, via the towing rod 13. An attachment is connected to the trailer 10 via a three-point link mechanism 17. Specifically, for example, attachments such as a rotary tedder 401 (see FIG. 15), a roll baler 402 (see FIG. 15), a spreader 403 (see FIG. 15), and a disc mower 404 (see FIG. 15) are connected. Accordingly, even in the vehicle 1 not having the PTO output shaft 19, the attachments 401 to 404 requiring the PTO output shaft 19 can be operated via the trailer 10.

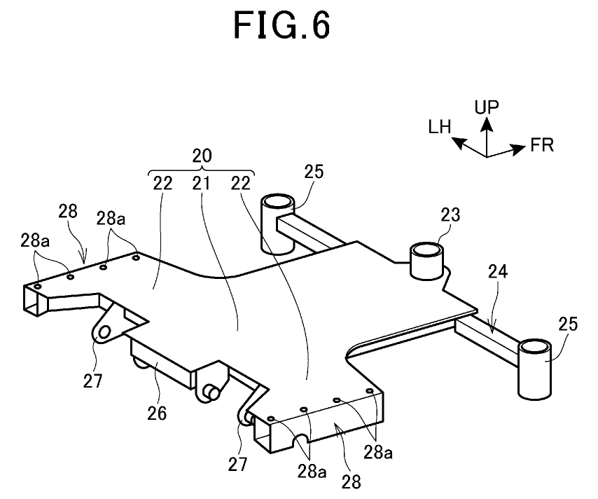

FIG. 6 is a perspective view of a base frame 20 of the trailer 10.

The main body portion 12 of the trailer 10 includes a metal plate-shaped base frame 20. The base frame 20 includes a frame central portion 21 having a rectangular plate shape in a vehicle plan view, and a pair of left and right frame side portions 22 provided on left and right sides of the rear portion of the frame central portion 21.

A steering pipe 23 extending in a vertical direction is provided at the front end of the frame central portion 21. The steering pipe 23 is provided at a lateral central portion.

A wheel support frame 24 extending in a left-right direction is fixed behind the steering pipe 23. Wheel support pipes 25 extending in the vertical direction are provided at both left and right ends of the wheel support frame 24.

A center shaft support portion 26 extending in the left-right direction is provided at the rear end portion of the frame central portion 21. Side shaft support portions 27 are provided on the left and right of the center shaft support portion 26. The side shaft support portion 27 is provided so as to face the center shaft support portion 26.

An arm support pipe portion (arm support portion) 28 is provided outside the side shaft support portion 27 in the left-right direction. The arm support pipe portion 28 is formed in an appearance of a rectangular tubular shape extending in a front-rear direction. The arm support pipe portion 28 is provided over the entire frame side portion 22 in the front-rear direction. In the arm support pipe portion 28, attachment holes 28a are formed at appropriate intervals in the front-rear direction.

As illustrated in FIG. 5, wheels 11 are rotatably supported at both left and right ends of the wheel support frame 24. In the present embodiment, the wheel 11 is supported by the wheel support frame 24 via a knuckle 11a. That is, a swing shaft 11b extending in the vertical direction is inserted through each of the wheel support pipes 25 at both ends of the wheel support frame 24, and the knuckle 11a is supported via the swing shaft 11b. The knuckle 11a is swingably supported about the swing shaft 11b. The wheel 11 is rotatably supported by the knuckle 11a. The left and right knuckles 11a are connected by a connection rod 11c extending in the left-right direction. Accordingly, the left and right wheels 11 are configured to be steered in the same direction.

The towing rod 13 extending forward is connected to a central portion of the left and right wheels 11. The towing rod 13 includes a rod base portion 31 connected to the steering pipe 23 and a rod extension portion 32 extending forward from the rod base portion 31.

The rod base portion 31 has a rectangular tubular shape. A swing shaft 33 extending in the vertical direction is provided at the rear end portion of the rod base portion 31. The swing shaft 33 is inserted into the steering pipe 23. The rod base portion 31 is swingably supported in the left-right direction by the swing shaft 33.

The rod extension portion 32 is connected to the front end of the rod base portion 31. A substantially U-shaped joint portion 34 (see FIG. 3) opened downward is provided at the rear end portion of the rod extension portion 32. The joint portion 34 is disposed so as to cover the front end portion of the rod base portion 31 from above. The joint portion 34 includes a swing shaft 34a (see FIG. 3) extending in the left-right direction. The rod extension portion 32 is connected to the rod base portion 31 via the swing shaft 34a. The rod extension portion 32 is swingable in the vertical direction about the swing shaft 34a with respect to the rod base portion 31. The rod extension portion 32 is swingable in the left-right direction about the swing shaft 33 integrally with the rod base portion 31.

Here, a steering rod 11d extending toward the knuckle 11a on one side in a vehicle width direction is connected to the towing rod 13 (see FIG. 5). The steering rod 11d is swingably connected to the towing rod 13. The steering rod 11d steers the knuckle 11a on one side in the vehicle width direction according to the steering angle of the towing rod 13 with respect to the base frame 20. Thus, the left and right wheels 11 are steered in a similar direction according to the steering angle of the towing rod 13.

A connection link 35 is provided at the front end of the rod extension portion 32. When the connection link 35 is connected to the vehicle 1, the trailer 10 is towed. Note that a power cable (not illustrated) extending from the power unit portion 15 is routed along the towing rod 13. The power cable is connected to a power supply (not illustrated) of the vehicle 1, for example, a battery. Accordingly, power is supplied to the power unit portion 15.

As illustrated in FIGS. 2-5, an auxiliary wheel 14 is supported by the arm support pipe portion 28 via an auxiliary wheel support member 40.

The auxiliary wheel support member 40 of the present embodiment includes an auxiliary wheel support arm 41 supported by the arm support pipe portion 28, a reinforcing arm 42 extending from a unit support frame 50 and reinforcing the auxiliary wheel support arm 41, an axle member (rotation shaft) 43 (see FIG. 4) supported by the auxiliary wheel support arm 41 and rotatably supporting the auxiliary wheel 14, and a support member 44 reinforcing the auxiliary wheel support arm 41 and the arm support pipe portion 28. The diameter of the auxiliary wheel 14 is similar to that of the wheel 11. Note that the trailer 10 can be used without providing the auxiliary wheels 14. That is, the trailer 10 can be used without providing the auxiliary wheel support member 40.

The frame central portion 21 of the base frame 20 is provided with the power unit portion 15 having an appearance of a rectangular parallelepiped shape. The power unit portion 15 includes a drive source that drives the three-point link mechanism 17 and the PTO output shaft 19. The power unit portion 15 includes a unit support frame (drive source support frame, frame portion) 50. The unit support frame 50 has a substantially rectangular parallelepiped frame shape.

The unit support frame 50 includes main frames 51 extending in the vertical direction. The main frames 51 are disposed corresponding to four corner shapes of the rectangular parallelepiped (see FIG. 5).

On both left and right sides, the front main frame 51 and the rear main frame 51 are connected by front-rear subframes (front-rear-wise subframes) 52 and 53 extending in the front-rear direction (see FIG. 2). The upper front-rear subframe 52 is provided corresponding to the upper end portions of the main frames 51. The lower front-rear subframe 53 is provided corresponding to the vertically intermediate portion of the main frame 51. Thus, hereinafter, the lower front-rear subframe 53 is referred to as an intermediate front-rear subframe 53.

An upper inclined frame 54 is supported above the intermediate front-rear subframe 53. The upper inclined frame 54 is inclined downward toward the rear. A lower inclined frame 55 is supported below the intermediate front-rear subframe 53. The lower inclined frame 55 is inclined upward toward the rear. Each of the upper inclined frame 54 and the lower inclined frame 55 is connected to the front and rear main frames 51. Respective rear end portions of each of the front-rear subframe 53, the upper inclined frame 54, and the lower inclined frame 55 are connected by a plate-shaped gusset portion 56.

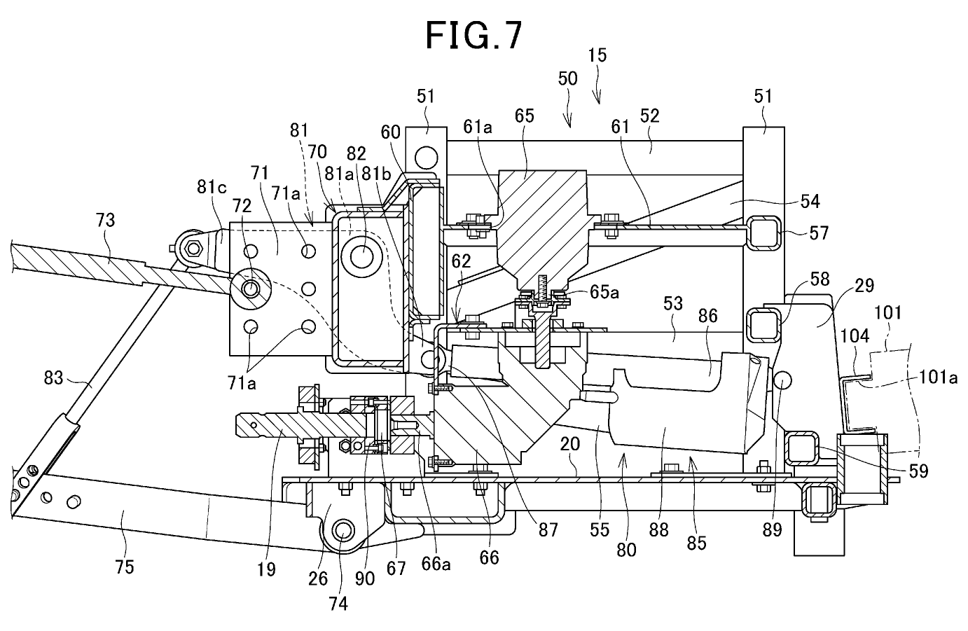

At the front end portion of the unit support frame 50, vertical three-stage width subframes (width-wise subframes) 57, 58, and 59 are disposed between the left and right main frames 51 (see FIGS. 3 and 7). The width subframes 57, 58, and 59 connect the left and right main frames 51.

The lower width subframe 59 is fixed to the front surface of the front main frame 51.

The intermediate width subframe 58 is provided according to the height of the intermediate front-rear subframe 53.

The upper width subframe 57 is provided above the intermediate width subframe 58 and below the upper front-rear subframe 52.

At the rear end portion of the unit support frame 50, a plate-shaped bracket fixing frame (width-wise subframe) 60 extending vertically and horizontally is connected between the left and right main frames 51 (see FIGS. 3 and 7). The bracket fixing frame 60 closes the upper portions of the left and right main frames 51 from behind. In other words, the bracket fixing frame 60 opens the lower portions of the left and right main frames 51 rearward.

FIG. 7 is a cross-sectional view of a main part of the trailer 10 corresponding to a cross section taken along line VII-VII of FIG. 5.

A plate-shaped cross frame (plate portion) 61 extending in the front-rear direction is provided between the bracket fixing frame 60 and the upper width subframe 57 on the front side. The cross frame 61 connects the upper width subframe 57 and the bracket fixing frame 60. The cross frame 61 is formed with a unit mounting port 61a that opens in a thickness direction.

A plate-shaped stay frame (plate portion) 62 extending in the left-right direction is provided below the unit mounting port 61a. The stay frame 62 is supported across the front-rear subframe 53 at the middle of both left and right sides.

Thus, in the unit support frame 50, three layers of a lower layer by the base frame 20, a middle layer by the stay frame 62, and an upper layer by the cross frame 61 are formed.

An electric motor 65 as a power unit is disposed on the upper cross frame 61. The electric motor 65 is mounted to the unit mounting port 61a such that a motor shaft 65a extends downward. The electric motor 65 is fixed to the cross frame 61.

A speed reducer 66 is disposed below the electric motor 65. The speed reducer 66 is supported by the stay frame 62. The speed reducer 66 is connected to the motor shaft 65a. The speed reducer 66 includes a transmission shaft 66a extending rearward. The speed reducer 66 converts, via a bevel gear or the like, the rotational force from the motor shaft 65a extending in the vertical direction into the rotation of the transmission shaft 66a extending in the front-rear direction turned 90 degrees. A coupling 67 is supported by the transmission shaft 66a. A coupling 90 of the PTO output shaft 19 is connected to the coupling 67.

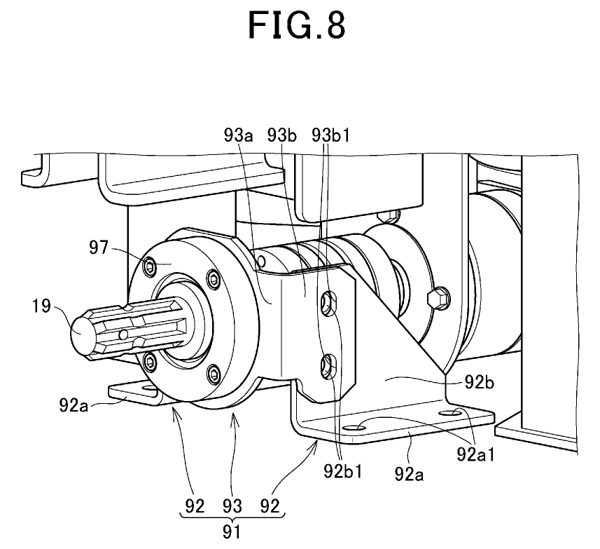

FIG. 8 is a perspective view illustrating a peripheral part of the PTO output shaft 19.

The PTO output shaft 19 is supported by the base frame 20 via a bracket 91. In the present embodiment, the bracket 91 includes a pair of left and right main body side brackets 92 fixed to the base frame 20 and an output shaft side bracket 93 fixed between the main body side brackets 92.

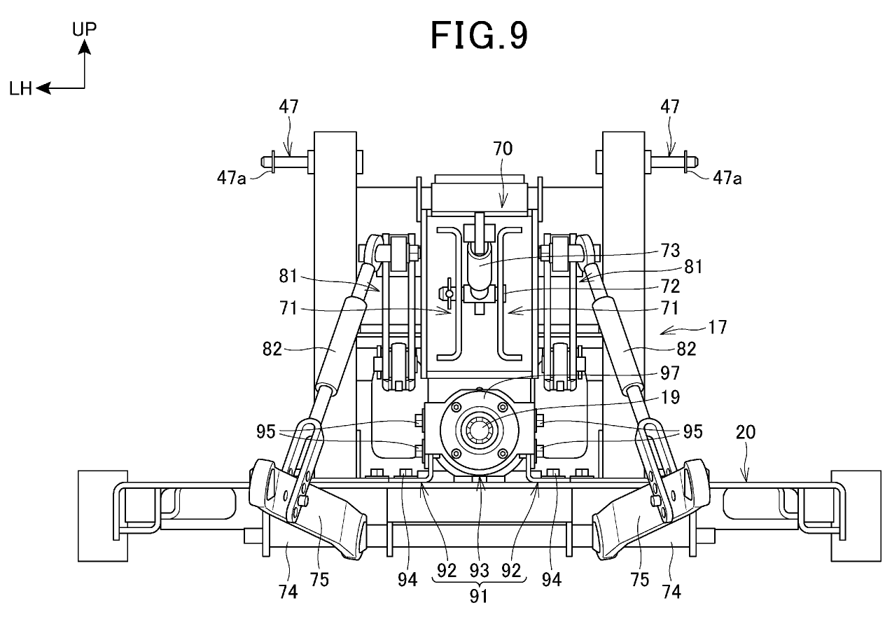

The main body side bracket 92 has an L shape in a vehicle rear view (see FIG. 9). Specifically, the main body side bracket 92 includes a bracket base portion 92a fixed to the base frame 20 and a bracket side portion 92b extending upward from an inner end of the bracket base portion 92a in the vehicle width direction. A long hole 92a1 extending in the left-right direction is formed in the bracket base portion 92a. A bolt (fixing tool) 94 (see FIG. 9) extending in the vertical direction is inserted into the long hole 92a1. The bolt 94 is fixed to the base frame 20. The long hole 92a1 allows the lateral position of the main body side bracket 92 with respect to the base frame 20 to be adjusted. A pair of upper and lower support holes 92b1 are formed in the bracket side portion 92b. In the present embodiment, the support hole 92b1 is a round hole. The output shaft side bracket 93 is fixed to the bracket side portion 92b.

The output shaft side bracket 93 has a substantially U shape. Specifically, the output shaft side bracket 93 includes an annular shaft support portion 93a through which the PTO output shaft 19 is supported, and bracket side portions 93b extending forward from both left and right sides of the shaft support portion 93a. The PTO output shaft 19 is rotatably supported by the shaft support portion 93a via a bearing 97. That is, the bearing 97 is fixed to the shaft support portion 93a, and the PTO output shaft 19 is supported by the bearing 97. A support hole 93b1 penetrating in the thickness direction, that is, the left-right direction is formed in the bracket side portion 93b. A pair of support holes 93b1 are formed above and below. The support hole 93b1 is formed to be larger than the support holes 92b1 of the output shaft side bracket 93. In the present embodiment, the support hole 93b1 is a long hole that is long in the vertical direction.

Here, the bracket side portion 93b of the output shaft side bracket 93 overlaps the lateral outside surface of the bracket side portion 92b of the main body side bracket 92. Further, a bolt (support member) 95 (see FIG. 9) extending in the left-right direction is inserted into the support hole 93b1. The bolt 95 is inserted through the support hole 92b1 of the main body side bracket 92 and fastened with a nut. Since the support hole 93b1 of the output shaft side bracket 93 is larger than the support hole 92b1 of the main body side bracket 92, the position of the output shaft side bracket 93 in the vertical direction can be adjusted with respect to the main body side bracket 92.

Here, the electric motor 65 and the speed reducer 66 are supported by the unit support frame 50. On the other hand, the PTO output shaft 19 is supported by the bracket 91. For this reason, axes of the transmission shaft 66a extending from the speed reducer 66 and the PTO output shaft 19 may not match due to an attachment error. In the present embodiment, the positions of the brackets 91 and 92 can be adjusted up, down, left, and right, so that the transmission shaft 66a extending from the speed reducer 66 and the PTO output shaft 19 can be easily connected with high accuracy. In addition, by connecting by the couplings 67 and 90, an error in the front-rear direction can also be absorbed.

FIG. 9 is a rear view of the main part of the trailer 10.

An arm bracket 70 is fixed to the rear surface of the bracket fixing frame 60. The arm bracket 70 includes a pair of left and right connection plate portions 71. A support hole 71a (see FIG. 7) penetrating in the thickness direction is formed in the connection plate portion 71. A support shaft 72 extending in the left-right direction is disposed in the support hole 71a. An upper link arm 73 constituting the three-point link mechanism 17 is connected to the support shaft 72. The upper link arm 73 extends rearward from the support shaft 72.

The upper link arm 73 is disposed between the left and right connection plate portions 71 and is swingable about the support shaft 72. In the present embodiment, a plurality of support holes 71a are formed in the connection plate portion 71, and the position of the swing center of the upper link arm 73 can be adjusted by changing the support hole 71a in which the support shaft 72 is supported.

Below the arm bracket 70, an arm shaft 74 extending in the left-right direction is supported by the center shaft support portion 26 and the side shaft support portion 27 (see FIG. 9). A pair of left and right arm shafts 74 are provided. The lower link arm 75 constituting the three-point link mechanism 17 is supported by the arm shaft 74. The lower link arm 75 is ball-joined to the arm shaft 74. The lower link arm 75 and the arm shaft 74 are connected by a connection member 76 (see FIG. 4).

A link drive mechanism 80 (see FIG. 7) is connected to the lower link arm 75. The link drive mechanism 80 includes a drive transmission arm 81 supported by the arm bracket 70. The drive transmission arm 81 extends in the front-rear direction. The drive transmission arm 81 includes a swing shaft portion 81a, a front arm portion 81b extending forward and downward from the swing shaft portion 81a, and a rear arm portion 81c extending rearward with respect to the swing shaft portion 81a.

The drive transmission arm 81 is swingably supported by the arm bracket 70 by a swing shaft 82 extending in the left-right direction.

A link rod 83 extending downward is swingably connected to the rear end of the rear arm portion 81c of the drive transmission arm 81. The link rod 83 is swingably connected to the lower link arm 75.

The front arm portion 81b of the drive transmission arm 81 is connected to a drive actuator 85. The drive actuator 85 of the present embodiment includes a cylinder portion 86 extending in the front-rear direction, a push rod portion 87 supported by the cylinder portion 86 in an expandable and retractable manner, and an electric drive unit 88 supported by the front portion of the cylinder portion 86. When the electric drive unit 88 is driven, the push rod portion 87 expands and retracts with respect to the cylinder portion 86. The front end of the cylinder portion 86 is connected to a stay 29 via a connection shaft 89 extending in the left-right direction. That is, the drive actuator 85 is swingably supported by the stay 29. The stay 29 is fixed across the intermediate width subframe 58 and the lower width subframe 59.

Thus, when the drive actuator 85 is operated, the push rod portion 87 moves rearward and pushes the front arm portion 81b on the lower side of the drive transmission arm 81 rearward. Thus, the drive transmission arm 81 rotates about the swing shaft portion 81a, and the rear arm portion 81c on the rear side moves upward. Therefore, the lower link arm 75 is rotated about the arm shaft 74 and lifted upward via the link rod 83 connected to the rear arm portion 81c.

At this time, since the front end side of the drive actuator 85 is swingably supported, the drive actuator 85 changes its posture to easily maintain balance when the front-to-rear length of the drive actuator 85 changes. Thus, it is easy to expand and retract the push rod portion 87.

Various attachments 401 to 404 such as the rotary tedder 401 (see FIG. 15), the roll baler 402 (see FIG. 15), the spreader 403 (see FIG. 15), and the disc mower 404 (see FIG. 15) can be connected to the three-point link mechanism 17 and the PTO output shaft 19.

A counter weight mechanism 100 (see FIG. 3) is provided at the front end portion of the base frame 20. The counter weight mechanism 100 includes a plurality of counter weights 101, 102, and 103 as weights. In addition, the counter weight mechanism 100 includes a pair of left and right weight stays 104 (see FIG. 7) to which the counter weights 101 to 103 are connected.

The weight stay 104 is fixed to the stay 29 at the front end portion of the base frame 20. The weight stay 104 has a U-shaped fitting portion shape with the front opened.

A first counter weight 101 is attached to the weight stay 104. The first counter weight 101 includes a fitting connection portion 101a (see FIG. 7) fitted to the weight stay 104 and a support portion 101b (see FIG. 3) capable of supporting a second counter weight 102.

The second counter weight 102 is attachable to the first counter weight 101. The second counter weight 102 has a connection portion 102a connected to the first counter weight 101 and a support portion 102b capable of supporting a third counter weight 103.

The third counter weight 103 is attachable to the second counter weight 102. The third counter weight 103 has a connection portion 103a connected to the second counter weight 102.

The weight stay 104 and the counter weights 101 to 103 are configured to be connectable to each other by a hole shape or a bolt.

In the counter weight mechanism 100, the counter weights 101 to 103 are appropriately mounted, and a load applied to the front end portion of the trailer 10 can be adjusted. Thus, by adjusting the weight of the front end portion of the trailer 10 according to the weight of the rear attachments 401 to 404 connected to the three-point link mechanism 17, the weight can be dispersed to the wheel 11 and the auxiliary wheel 14 in a well-balanced manner. Accordingly, the posture of the trailer 10 can be easily held, and the weight of the attachments 401 to 404 can be less likely to affect the vehicle 1 towing the trailer 10.

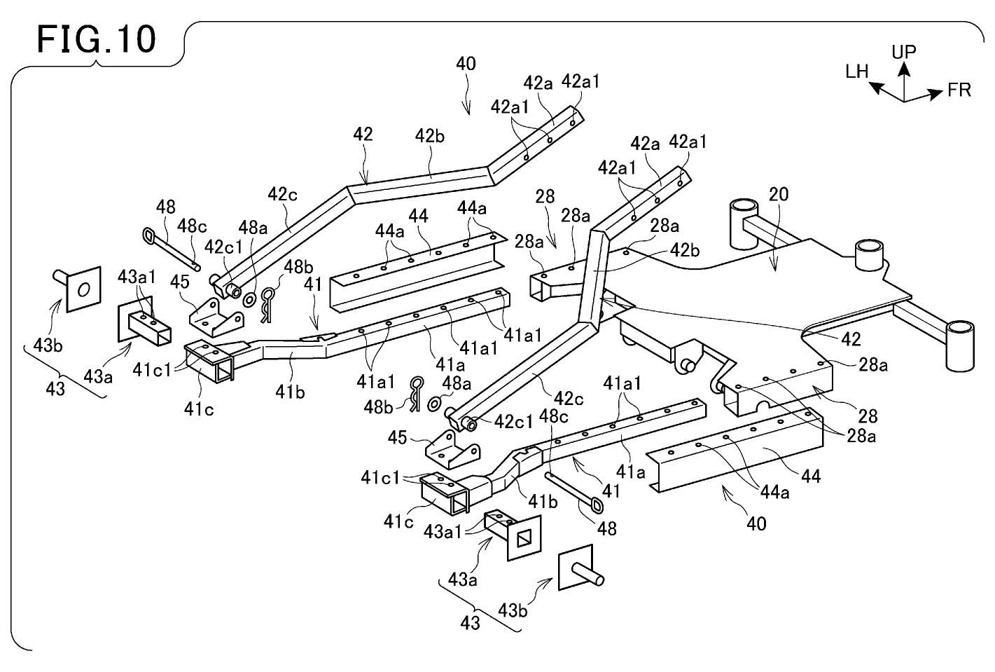

FIG. 10 is an exploded perspective view of a first auxiliary wheel support member 40.

A pair of left and right first auxiliary wheel support members 40 are provided. The first auxiliary wheel support members 40 are configured to be laterally symmetrical. The first auxiliary wheel support member 40 includes an auxiliary wheel support arm (support arm) 41.

The auxiliary wheel support arm 41 includes an insertion rectangular pipe portion 41a extending in the front-rear direction, an offset portion 41b inclined outward in the vehicle width direction from the rear end of the insertion rectangular pipe portion 41a toward a rear side, and an auxiliary wheel support portion 41c connected to the rear end of the offset portion 41b.

The insertion rectangular pipe portion 41a is formed in a size slightly smaller than the rectangular tubular shape of the arm support pipe portion 28. The insertion rectangular pipe portion 41a has a plurality of fastening hole portions (attachment portions) 41a1 formed in the front-rear direction. A bolt 46 (see FIG. 3) can be fastened to the fastening hole portion 41a1. The fastening hole portions 41a1 are formed at predetermined intervals. In the present embodiment, six fastening hole portions 41a1 are formed. The insertion rectangular pipe portion 41a is inserted into the rectangular tubular shape of the arm support pipe portion 28. The insertion rectangular pipe portion 41a is inserted such that the fastening hole portion 41a1 coincides with the attachment hole 28a of the arm support pipe portion 28. The insertion rectangular pipe portion 41a is inserted such that at least two of the fastening hole portions 41a1 coincide with the attachment holes 28a. In other words, the insertion rectangular pipe portion 41a is configured such that an attachment amount with respect to the arm support pipe portion 28 can be adjusted in three stages. At this time, since the insertion rectangular pipe portion 41a and the arm support pipe portion 28 each have a rectangular tubular shape, the insertion rectangular pipe portion 41a can be temporarily supported in a state where the attachment amount of the auxiliary wheel support arm 41 is adjusted.

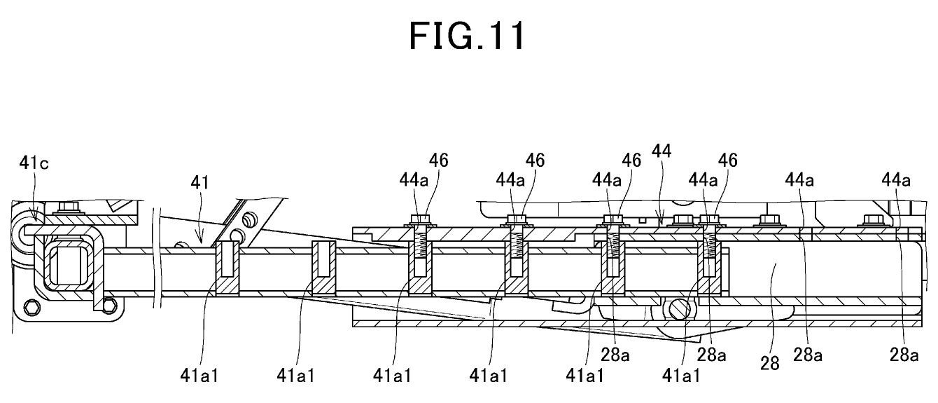

FIG. 11 is a cross-sectional view taken along line XI-XI of FIG. 5.

The support member (reinforcing support portion) 44 of the first auxiliary wheel support member 40 extends in the front-rear direction. The support member 44 has a substantially U-shaped cross section with the inside in the vehicle width direction opened. That is, the support member 44 has a shape in which one surface of the rectangular tubular shape is omitted. An insertion hole 44a is formed in the upper surface of the support member 44. The insertion hole 44a is formed in a manner similar to that of the interval of the fastening hole portions 41a1 in the auxiliary wheel support arm 41.

The support member 44 is mounted to the arm support pipe portion 28 so as to sandwich the arm support pipe portion 28 between the upper surface and the lower surface. At this time, the support member 44 is disposed such that the insertion hole 44a at the front end coincides with the attachment hole 28a at the front end of the arm support pipe portion 28. For example, the bolt 46 is inserted into the insertion hole 44a such that the bolt 46 is fastened to the fastening hole portion 41a1 at the front end of the insertion rectangular pipe portion 41a and three fastening hole portions 41a1 continuous from the fastening hole portion 41a1 at the rear end of the insertion rectangular pipe portion 41a. By fastening the bolt 46, the insertion rectangular pipe portion 41a is fixed to the arm support pipe portion 28 in a state of being reinforced by the support member 44.

The auxiliary wheel support portion 41c is formed at the rear end portion of the auxiliary wheel support arm 41. The auxiliary wheel support portion 41c has a rectangular tubular shape extending in the left-right direction. The auxiliary wheel support portion 41c has an upper surface having an insertion hole 41c1. A connection bracket 45 having a U-shaped cross section is provided on the upper surface.

The reinforcing arm (sub-arm) 42 of the first auxiliary wheel support member 40 has a front portion 42a extending in the front-rear direction, an intermediate portion 42b inclined outward in the vehicle width direction from the front portion 42a toward a rear side, and a rear portion 42c extending rearward from the rear end of the intermediate portion 42b.

A plurality of attachment holes (attachment portions) 42a1 penetrating in the vehicle width direction are formed in the front portion 42a. In the present embodiment, three attachment holes 42a1 are formed in the front portion 42a according to a configuration where the insertion rectangular pipe portion 41a of the auxiliary wheel support arm 41 can be adjusted in three stages.

A connection pin 47 (see FIG. 9) at the upper end portion of the unit support frame 50 is inserted into one of the attachment holes 42a1 of the reinforcing arm 42 in accordance with the extension/retraction amount of the auxiliary wheel support arm 41. Here, the connection pin 47 is provided at the upper end portion of the main frame 51 on the rear side. The connection pin 47 extends outward in the left-right direction. The connection pin 47 is inserted into the attachment hole 42a1, and a retainer 47a is fixed to the distal end thereof. By inserting the connection pin 47, the reinforcing arm 42 can be easily connected to the unit support frame 50.

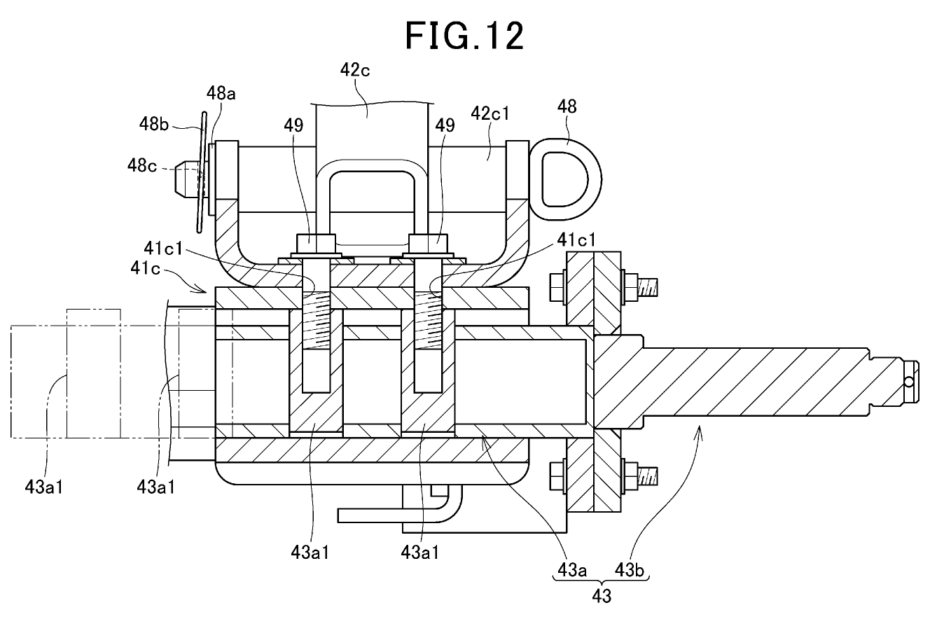

The rear portion 42c of the reinforcing arm 42 is provided with a pipe portion 42c1 extending in the left-right direction. The pipe portion 42c1 is disposed between the connection brackets 45. Then, a shaft-shaped engagement pin 48 extending in the left-right direction passes through the connection bracket 45 and the pipe portion 42c1. A washer 48a is mounted on a distal end portion of the engagement pin 48, and a retaining pin 48b is mounted on a distal end side of the engagement pin 48 with respect to the washer 48a (see FIGS. 10 and 12). The retaining pin 48b is mounted to a hole 48c at the distal end portion of the engagement pin 48. By being connected to the connection bracket 45 with the swingable structure of the engagement pin 48 and the pipe portion 42c1, the reinforcing arm 42 having an inclination angle different according to the extension/retraction amount of the auxiliary wheel support arm 41 can be easily connected.

Note that the retaining structure of the connection pin 47 inserted into the attachment hole 42a1 on the front end side of the reinforcing arm 42 may be also configured similarly to the retaining structure of the engagement pin 48.

FIG. 12 is a cross-sectional view taken along line XII-XII of FIG. 5.

The axle member 43 is supported by the auxiliary wheel support portion 41c of the auxiliary wheel support arm 41. The axle member 43 includes a flanged rectangular pipe portion 43a having a rectangular pipe portion extending in the left-right direction, and a flanged axle portion 43b having an axle extending in the left-right direction. The flanged rectangular pipe portion 43a and the flanged axle portion 43b are fixed and integrated by bolts.

A plurality of fastening hole portions 43a1 are formed in the flanged rectangular pipe portion 43a in the left-right direction. A bolt 49 can be fastened to the fastening hole portion 43a1. The fastening hole portions 43a1 are formed at predetermined intervals. In the present embodiment, two fastening hole portions 43a1 are formed. The flanged rectangular pipe portion 43a can be temporarily supported by being inserted into the rectangular pipe of the auxiliary wheel support portion 41c. The connection bracket 45 and the auxiliary wheel support portion 41c are fastened together by the bolt 49. The auxiliary wheel 14 is rotatably supported by the axle member 43.

The extension/retraction amount of the auxiliary wheel support arm 41 can be changed by adjusting the amount of insertion into the arm support pipe portion 28. In addition, the attachment position of the reinforcing arm 42 can also be changed. Thus, the position of the auxiliary wheel 14 with respect to the base frame 20 can be changed.

In addition, the position of the auxiliary wheel 14 in the vehicle width direction with respect to the auxiliary wheel support portion 41c may be adjustable. For example, the flanged rectangular pipe portion 43a may be elongated in the left-right direction, and a plurality of fastening hole portions 43a1 may be provided (see a two-dot chain line in FIG. 12). Accordingly, since the position of the axle member 43 in the left-right direction can be adjusted with respect to the auxiliary wheel support portion 41c, the position of the auxiliary wheel 14 in the left-right direction can be adjusted.

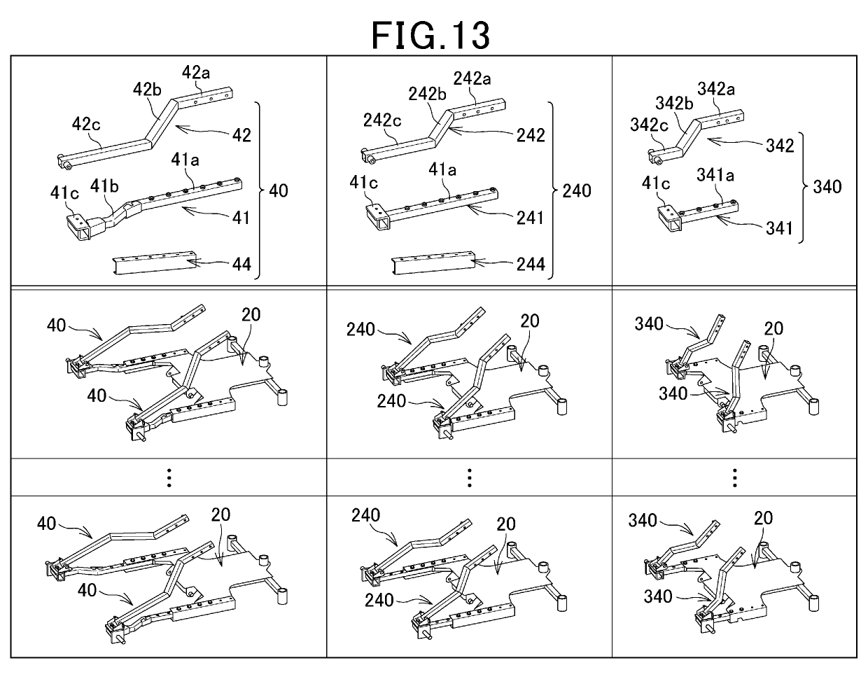

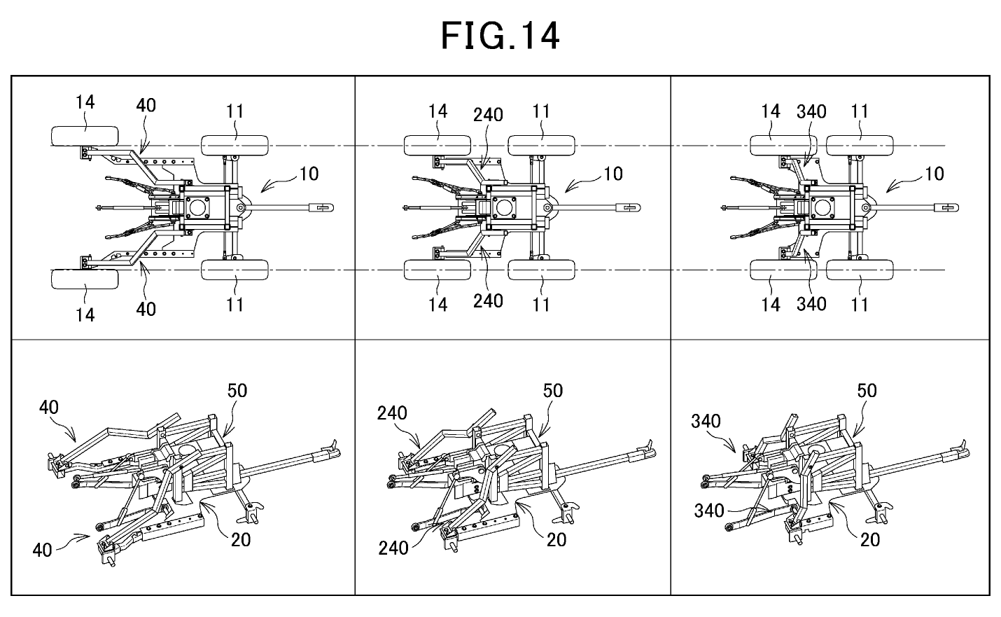

FIG. 13 is a view illustrating variations of auxiliary wheel support members 40, 240, and 340 of the trailer 10 according to the embodiment. Main components of the auxiliary wheel support members 40, 240, and 340 are illustrated in the upper part of a double line in FIG. 13. The lower part of the double line in FIG. 13 illustrates how to attach the auxiliary wheel support members 40, 240, and 340. FIG. 14 is a view illustrating a state of the trailer 10 when the auxiliary wheel support members 40, 240, and 340 are attached. The upper part of FIG. 14 illustrates a plan view of the trailer 10. The lower part of FIG. 14 illustrates a relationship among the auxiliary wheel support members 40, 240, and 340, the base frame 20, and the unit support frame 50.

In the trailer 10 of the present embodiment, the plurality of auxiliary wheel support members 40, 240, and 340 can be selectively used. That is, in the present embodiment, the position of the auxiliary wheel 14 in the trailer 10 can be adjusted by replacing the auxiliary wheel support members 40, 240, and 340. Each of the auxiliary wheel support members 40, 240, and 340 can adjust the position of the auxiliary wheel 14 in three stages.

The second auxiliary wheel support member 240 is used in a case where it is desired to bring the auxiliary wheel 14 closer to the wheel 11 than the first auxiliary wheel support member 40.

An auxiliary wheel support arm (support arm) 241 of the second auxiliary wheel support member 240 is different from the auxiliary wheel support arm 41 of the first auxiliary wheel support member 40 in that the offset portion 41b is omitted (see the upper part of FIG. 13). That is, in the auxiliary wheel support arm 241, the auxiliary wheel support portion 41c is formed at the rear end portion of the insertion rectangular pipe portion 41a. Note that since the offset portion 41b is omitted in the auxiliary wheel support arm 241 of the second auxiliary wheel support member 240, the auxiliary wheel 14 is disposed inside in the vehicle width direction as compared with the first auxiliary wheel support member 40 (see the upper part of FIG. 14).

The reinforcing arm (sub-arm) 242 of the second auxiliary wheel support member 240 is formed shorter in the front-rear direction and the vehicle width direction than the reinforcing arm 42 of the first auxiliary wheel support member 40. In the reinforcing arm 242, a front portion 242a, an intermediate portion 241b, and a rear portion 242b are formed according to the attachment place of the auxiliary wheel support arm 241 (see the upper part of FIG. 13).

The third auxiliary wheel support member 340 is used in a case where it is desired to bring the auxiliary wheel 14 closer to the wheel 11 than the second auxiliary wheel support member 240.

The auxiliary wheel support arm (support arm) 341 of the third auxiliary wheel support member 340 is different in that the length of the insertion rectangular pipe portion 341a is shorter than the insertion rectangular pipe portion 41a of the auxiliary wheel support arm 241 in the second auxiliary wheel support member 240 (see the upper part of FIG. 13). That is, in the auxiliary wheel support arm 341, the insertion rectangular pipe portion 341a has such a length that four fastening hole portions 41a1 are formed.

The reinforcing arm (sub-arm) 342 of the third auxiliary wheel support member 340 is formed shorter in the front-rear direction than the reinforcing arm 242 of the second auxiliary wheel support member 240. In the reinforcing arm 342, a front portion 342a, an intermediate portion 341b, and a rear portion 342b are formed according to the attachment place of the auxiliary wheel support arm 341 (see the upper part of FIG. 13).

In the third auxiliary wheel support member 340, the support member 44 is not used.

FIG. 15 is a functional explanatory diagram of the embodiment.

In the present embodiment, the position of auxiliary wheel 14 with respect to wheel 11 can be adjusted by appropriately replacing the auxiliary wheel support members 40, 240, and 340. In addition, it is also possible to omit the auxiliary wheel 14 by not providing the auxiliary wheel support members 40, 240, and 340. Furthermore, the combination and omission of the auxiliary wheel support members 40, 240, and 340 may be different between the left and right of the main body portion 12.

Thus, for example, as indicated by arrows A1 and A2, in a case where ground contact wheels 401a and 402a are provided in the attachments 401 and 402, the attachments 401 and 402 may be connected to the trailer 10 without providing the auxiliary wheel support members 40, 240, and 340.

In addition, for example, as indicated by an arrow A3, the auxiliary wheel support members 40 having the same size may be provided on the left and right, and the attachment 403 may be connected to the trailer 10.

Furthermore, for example, as indicated by an arrow A4, in a case where the attachment 404 protruding to one side in the left-right direction is provided, the attachment 404 can be connected to the trailer 10 while stabilizing the trailer 10 by providing the auxiliary wheel support member 340 having a short size on one side in the left-right direction and providing the auxiliary wheel support member 40, which is longer than that on the one side in the left-right direction, on the other side in the left-right direction.

Thus, the attachments 401 to 404 can be flexibly used by the trailer 10.

As described above, according to the present embodiment, the trailer 10, which includes the main body portion 12 constituting the trailer, at least two left and right wheels 11 supported by the main body portion 12, and the towing rod 13 connecting the main body portion 12 to the vehicle 1, and is towed by the vehicle 1, includes the three-point link mechanism 17 to which various attachments 401 to 404 are detachably connected; and the auxiliary wheel 14 that is supported so as to be changeable in position with respect to the main body portion 12.

According to this configuration, the auxiliary wheel 14 is provided, so that the trailer 10 can be easily stabilized and the trailer 10 can be easily used without being limited to the vehicle 1, as compared with the structure of only the left and right wheels 11. In addition, the position of the auxiliary wheel 14 can be changed according to the attachments 401 to 404. Therefore, according to this configuration, it is possible to provide the trailer 10 that is capable of use without being limited to the vehicle 1 and flexible use with the attachments 401 to 404.

In the present embodiment, the auxiliary wheel 14 is supported via the auxiliary wheel support arm 41, 241, 341 detachably supported by the main body portion 12, and the auxiliary wheel support arm 41, 241, 341 includes the auxiliary wheel support portion 41c at one end and includes a plurality of fastening hole portions 41a1 at the other end.

According to this configuration, it is possible to realize a configuration in which the position of the auxiliary wheel 14 can be changed with a simple structure by the auxiliary wheel support arm 41, 241, 341.

In addition, in the present embodiment, the main body portion 12 includes the arm support pipe portion 28 that supports the auxiliary wheel support arm 41, 241, 341, the arm support pipe portion 28 has a tubular shape that slidably supports the auxiliary wheel support arm 41, 241, 341, the support member 44 capable of extending an attachment position of the auxiliary wheel support arm 41, 241, 341 is provided, and the support member 44 is detachably supported by the arm support pipe portion 28.

According to this configuration, by the support member 44, the auxiliary wheel 14 can be disposed at a position further away from the main body portion 12 in a state of maintaining rigidity, and a wider variety of attachments 401 to 404 can be easily used.

In addition, in the present embodiment, the three-point link mechanism 17 includes at least the upper link arm 73 that is swingably supported by the unit support frame 50 extending upward from the main body portion 12, one end of the reinforcing arm 42, 242, 342 is swingably supported at one end of the auxiliary wheel support arm 41, 241, 341, the other end of the reinforcing arm 42, 242, 342 is supported by the unit support frame 50, and a plurality of attachment holes 42a1 attached to the unit support frame 50 are provided at the other end of the reinforcing arm 42, 242, 342.

According to this configuration, with the swingable structure, even if the attachment angle of the reinforcing arm 42, 242, 342 extending from the unit support frame 50 varies, the reinforcing arm 42, 242, 342 can support the auxiliary wheel support arm 41, 241, 341 with a simple structure.

In addition, in the present embodiment, the auxiliary wheel support portion 41c attaches the axle member 43 of the auxiliary wheel 14 so as to be expandable and retractable in a vehicle width direction (left-right direction).

According to this configuration, the position of the auxiliary wheel 14 in the vehicle width direction can be adjusted.

### Other Embodiments

The embodiments described above are merely an aspect of the present invention, and can be arbitrarily modified and applied within a scope not departing from the spirit of the present invention.

### Configurations supported by above embodiments

The embodiments described above support the following configurations.

Configuration 1) A trailer that includes a main body portion constituting the trailer, at least two left and right wheels supported by the main body portion, and a connection portion connecting the main body portion to a vehicle, and is towed by the vehicle, the trailer comprising: an attachment connection portion to which various attachments are detachably connected; and an auxiliary wheel that is supported so as to be changeable in position with respect to the main body portion.

According to this configuration, the auxiliary wheel is provided, so that the trailer can be easily stabilized and the trailer can be easily used without being limited to the vehicle, as compared with the structure of only the left and right wheels. In addition, the position of the auxiliary wheel can be changed according to the attachments. Therefore, according to this configuration, it is possible to provide the trailer that is capable of use without being limited to the vehicle and flexible use with the attachments.

Configuration 2) The trailer according to Configuration 1, in which the auxiliary wheel is supported via a support arm detachably supported by the main body portion, and the support arm includes an auxiliary wheel support portion at one end, and includes a plurality of attachment portions at another end.

According to this configuration, it is possible to realize a configuration in which the position of the auxiliary wheel can be changed with a simple structure by the support arm.

Configuration 3) The trailer according to Configuration 2, in which the main body portion includes an arm support portion that supports the support arm, the arm support portion has a tubular shape that slidably supports the support arm, a reinforcing support portion capable of extending an attachment position of the support arm is provided, and the reinforcing support portion is detachably supported by the arm support portion.

According to this configuration, by the reinforcing support portion, the auxiliary wheel can be disposed at a position further away from the main body portion in a state of maintaining rigidity, and a wider variety of attachments can be easily used.

Configuration 4) The trailer according to Configuration 2 or 3, in which the attachment connection portion includes at least an upper link arm that is swingably supported by a frame portion extending upward from the main body portion, one end of a sub-arm is swingably supported by one end of the support arm, the other end of the sub-arm is supported by the frame portion, and a plurality of attachment portions attached to the frame portion are provided at the other end of the sub-arm.

According to this configuration, with the swingable structure, even if the attachment angle of the sub-arm extending from the frame portion varies, the sub-arm can support the support arm with a simple structure.

Configuration 5) The trailer according to Configuration 2 or 3, in which the auxiliary wheel support portion attaches a rotation shaft of the auxiliary wheel so as to be expandable and retractable in a vehicle width direction.

According to this configuration, the position of the auxiliary wheel in the vehicle width direction can be adjusted.

### REFERENCE SIGNS LIST

1 Vehicle

10 Trailer

11 Wheel

12 Main body portion

13 Towing rod (connection portion)

14 Auxiliary wheel

17 Three-point link mechanism (attachment connection portion)

28 Arm support pipe portion (arm support portion)

41 Auxiliary wheel support arm (support arm)

41a1 Fastening hole portion (attachment portion)

41c Auxiliary wheel support portion

42 Reinforcing arm (sub-arm)

42a1 Attachment hole (attachment portion)

43 Axle member (rotation shaft)

44 Support member (reinforcing support portion)

50 Unit support frame (frame portion)

73 Upper link arm

241 Auxiliary wheel support arm (support arm)

242 Reinforcing arm (sub-arm)

341 Auxiliary wheel support arm (support arm)

342 Reinforcing arm (sub-arm)

401 Rotary tedder (attachment)

402 Roll baler (attachment)

403 Spreader (attachment)

404 Disc mower (attachment)

What is claimed is:

1. A trailer that includes a main body portion constituting the trailer, at least two left and right wheels supported by the main body portion, and a connection portion connecting the main body portion to a vehicle, and is towed by the vehicle, the trailer comprising:
an attachment connection portion to which various attachments are detachably connected; and
an auxiliary wheel that is supported so as to be changeable in position with respect to the main body portion.

2. The trailer according to claim 1, wherein
the auxiliary wheel is supported via a support arm detachably supported by the main body portion, and
the support arm includes an auxiliary wheel support portion at one end, and
includes a plurality of attachment portions at another end.

3. The trailer according to claim 2, wherein
the main body portion includes an arm support portion that supports the support arm,
the arm support portion has a tubular shape that slidably supports the support arm,
a reinforcing support portion capable of extending an attachment position of the support arm is provided, and
the reinforcing support portion is detachably supported by the arm support portion.

4. The trailer according to claim 2, wherein
the attachment connection portion includes at least an upper link arm that is swingably supported by a frame portion extending upward from the main body portion,
one end of a sub-arm is swingably supported by one end of the support arm,
another end of the sub-arm is supported by the frame portion, and
a plurality of attachment portions attached to the frame portion are provided at the other end of the sub-arm.

5. The trailer according to claim 2, wherein
the auxiliary wheel support portion attaches a rotation shaft of the auxiliary wheel so as to be expandable and retractable in a vehicle width direction.
